(19) United States
(12) Patent Application Publication
(10) Pub. No.: US 2024/0112261 A1
(43) Pub. Date: Apr. 4, 2024

(54) REAL TIME SYSTEM WITH ARTIFICIAL INTELLIGENCE (AI) MECHANISM FOR RECTIFYING TRADING REQUESTS DENIED BASED ON ASSOCIATED INVESTMENT POLICY (AIP) GOVERNANCE

(71) Applicant: Bank of America Corporation, Charlotte, NC (US)

(72) Inventors: Aravind Shankaragouda Singtalur, McKinney, TX (US); Manmohan V. Datla-Viswasai, Frisco, TX (US); Petar Puskarich, Plano, TX (US); Srinath Chakravarty, Plano, TX (US); Steven Greene, New York, NY (US); Dinesh Kumar Agrawal, Rowlett, TX (US); Kenneth Boyd, Richmond, VA (US); Kerry Vaughan, Pennington, NJ (US); Stephen Belton, Garden City, NY (US)

(21) Appl. No.: 17/958,491

(22) Filed: Oct. 3, 2022

(51) Int. Cl. G06Q 40/04

(52) U.S. Cl. CPC G06Q 40/04

(57) ABSTRACT

A computer system for integrating trading account security with associate investment policy (AIP) governance is provided. The system includes a processor and a receiver. A received trade request may include an associate social security number, an associate name, a security name, a last security purchase data, and a broker dealer name. The employee may be a private side employee. The processor may use a series of containers in electronic communication with a database or database engine to determine that the trade request is industry compliant and employer regulations compliant. When the trade request is determined to be non-compliant, then the processor may electronically message or e-mail the employee 1) a trade denial and 2) insider trading mitigation messages. Following a determination that the trade request is fully compliant; the processor may transmit the trade request to an employer trading platform and prompt the associate to execute the trade request.

### FIELD OF TECHNOLOGY

Aspects of the disclosure relate to providing solutions to breaches in security associated with AIP.

### BACKGROUND OF THE DISCLOSURE

Associate Investment Policy (AIP) addresses regulatory requirements and supplements a corporate code of conduct. An entity's corporate code of contact typically applies to its employees. In addition, there may be obligations that devolve on any person or party associated with the entity. For the purposes of this application, the term associate should be understood to refer to an entity employee, a vendor and/or any other suitable person or entity that is associated at some level with the entity.

In corporations, associate securities trading may present a conflict of interest between an employee(s) and the company and/or between employees and company clients. Trading involving such conflicts of interests or generally trading in violation of regulatory requirements, such as trading based on Material Non-Public Information (“MNPI”), is generally collectively referred to as “insider trading.” With respect to such insider trading, the employee's interests are placed ahead of, and typically to the detriment of, an entity, its clients and/or the public at large.

Legacy systems for preventing or mitigating the damage of associate insider trading include systems that have been designed and established to prevent insider trading and the misuse of MNPI, and to prevent other conflicts of interest involving an entity and its employees.

However, legacy systems still have challenges. For example, current systems fail to account for human error in researching policy terms, inaccurate pre-clearance information, no stops on trade execution even if a trading policy is violated, obscurity of, and difficulty in detecting, undisclosed trading accounts, a multiplicity of human touch points to complete, high regulatory and reputational risk to an entity and its clients, overhead in governance and enforcement of the policy itself.

Accordingly, it would be desirable to provide technical solutions that provide, in substantially real time, systems and methods that integrate trading account security with AIP governance.

### SUMMARY OF THE DISCLOSURE

It is an object of the invention to provide, in substantially real time, systems and methods that integrate trading account security with AIP governance. A method for integrating trading account security with associate investment policy (AIP) governance is provided. The method may include receiving, from an associate via an associate trading platform, an associate trade request, said trade request comprising an associate social security number (SSN), an associate name, a name of a security to which the trade request is directed, a last security purchase data, the last security purchase data associated with the security, and a broker dealer name to which the trade request is directed. The method may also include determining that the employee is a private side employee. When the employee is a private side employee, the method uses a series of containers in electronic communication with a database or database engine to determine that the trade request is industry compliant. The containers may also be used to determine that the trade request is employer regulations compliant. Following a determination that the trade request is industry compliant and employer regulations compliant, the method may include transmitting the trade request to an employer platform. The method may also include, following the transmitting the trade request to the employer platform, informing the employee that the employee can execute the trade request within a pre-determined time period. The method may also include prompting the employee with a selectable option to execute the trade request when the trade request is determined to be non-compliant. In addition, the method may also include electronically messaging or e-mailing the employee 1) a trade denial and 2) insider trading mitigation messages to obtain reduced future insider trading.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram for use in accordance with principles of the disclosure;

FIG. 2 shows another illustrative diagram for use in accordance with principles of the disclosure;

FIG. 3 shows an illustrative flow diagram in accordance with the principles of the disclosure;

FIG. 4 shows an illustrative flow diagram of an embodiment of a process, using one or more of the systems described herein, that leverages AI to improve compliance with various trading regulations; and

FIG. 5 shows another illustrative flow diagram of an embodiment of a process, using one or more of the systems described herein, that leverages AI to improve compliance with various trading regulations.

### DETAILED DESCRIPTION OF THE DISCLOSURE

In embodiments of the disclosure, an employee may initiate a trade request from a trading account in a preferably entity-agnostic trading platform, such as a Merrill Lynch®, Fidelity® or other suitable trading platform. This trading account, which, in the embodiments disclosed herein, preferably connects to an employer's AIP governance system, and either directly or through the AIP governance system, sends required data points for real-time, or substantially real-time, accurate pre-clearance decision-making by an employer's platform.

Upon pre-clearance approval by the employer's platform, a response may be sent to the trading platform to execute the trade within a stipulated deadline. If pre-clearance is denied by employer's platform, then a response is sent to the trading platform to notify the associate that the trade has been denied and the transaction has been halted. Because the unapproved trade is preferably stopped prior to trade execution, it saves associate investment monitoring team's time from researching, contacting employees and/or issuing consequence letters in the event unapproved or disallowed trading had been executed.

From the foregoing, it has been shown that the embodiments disclosed herein describe a robust, real-time integration between a trading account and an AIP governance system which preferably prevents, prior to execution, insider trading and protects employees, Financial Institutions (FIs), other suitable entities and entity clients from regulatory and reputational risks.

Furthermore, such embodiments preferably serve to reduce human error in assessing trades vis-à-vis the existence of violations of AIP governance and regulations. It should be noted that pre-clearance decisions may also involve, and be based on, real-time actual data as opposed to historic data.

The embodiments provide a unified end-to-end process. This process preferably provides one stop, substantially all inclusive, active monitoring from trade initiation to pre-clearance to actual trading.

In addition, real time operational systems and methods preferably are configured to act as a service platform that can be used by other FIs, and/or other suitable entities and entity clients to mitigate regulatory/reputational damage.

Some embodiments of the invention are also configured to detect undisclosed associated trading accounts and preferably stop trade execution prior to occurrence of violation and potential regulatory/reputational damage.

The approaches set forth herein preferably leverage Java Microservices application performance, or other suitable container-based applications, together with Mongo Database, or other suitable database, engine abilities to maintain trading policy compliance.

Further value associated with the embodiments of the disclosure may include preventing Associate Investment Monitoring (AIM) violations, protecting employees from unintentional violations and increasing the security of associate transactions and trades.

Advantages of the current embodiments over legacy processes include the fact that legacy processes are typically limited to an individual employer only—while the embodiments set forth herein preferably provide scalable systems and methods that can be configured to be employer- and/or trading platform-agnostic. Such a shared solution for common covered individuals is not currently known to exist.

In terms of the ease-of-use of the embodiments, the shared solutions described herein are employee initiated at trading platforms. As such, the compliance checks set forth herein are wholly, or at least partially, transparent to the associate. The level of transparency to the associates may be system set in order to maximize the associate's safety and security.

Furthermore, the integration of industry-wide compliance checks across supporting trading platforms increases scalability of the system. And, management by employer platforms for updates of custom compliance rules prevents compliance rule changes from being followed. Also—the embodiments enable integration of service into substantially any application base. Finally, solutions according to the current disclosure automate, substantially in real-time, compliance checks by the employer.

Processes according to the embodiments may be initiated when a user, such as an entity associate, contacts a trading platform of choice. The user may initiate a trade at the trading platform.

In some embodiments, the trading platform may be configured to then send data, which may be required in certain embodiments, to a system according to the embodiments. The system may—in certain embodiments, be configured to provide at least in part software as a service (SaaS) responses and/or operations as will be described in more detail hereinbelow.

The system, according to the embodiments, may preferably invoke scalability, as follows, from this point in the process. Accordingly, the trading platform may be invoked as any suitable trading platform to connect to the system according to the embodiments, which adds to the scalability. The final step in the scalability is that the system, on the back end—i.e., between the trading platform and the AIP governance system, and further between the AIP governance system employer platform, is preferably to connect with and communicate with the employer platform to “close the loop” on the AIP governance as set forth in more detail hereinbelow.

With regard to the process within the system, initial global checkpoints may be completed using the containers within Microservices, or using any suitable system. These containers may be configured to process one or more of the social security number (SSN), the employer name, the name of the security being traded, the last security purchase date of the associate, the broker dealer name associated with the trade and/or any other suitable information used by system review.

Employer based checkpoints are completed within Microservices. These checkpoints may include industry regulations compliancy, employer regulations compliancy and/or Line of Business (LOB) compliancy as well as any other compliancy necessary to secure the transaction according to appropriate AIP governance.

It should be noted that industry regulations compliancy may include such issues as disclosure of all the associates', or the associates immediate family's, trading accounts to the relevant parties, trading restrictions during black-out periods such as periods immediately prior to entity earnings' announcements, and/or a pre-determined hold period after purchasing a security, such as a time period in which security trading an entities' securities are prohibited from trading such as a period before the end of each fiscal quarter through the end of the trading day on which financial results for that quarter are released to the public and an LIFO (Last In First Out) policy for unlocking the hold period—i.e., preferably all hold periods are determined from the last-in-time purchase. Accordingly, if two purchases were made by an associate within the pre-determined time period, the first purchased security cannot be sold until the expiration of the pre-determined time period following the second purchase. It should be noted that the foregoing represents a limited number of possible compliance issues, but the disclosure should be understood to relate to all relevant compliancy issues.

Systems and method of the disclosure may also provide a pre-determined time window following transaction authorization in which the authorization enables the transaction to be executed. Certain embodiments of such an authorization may include, preferably in response to receiving a selectable opt-in selection from an associate, automated execution of the trade following authorization. Alternatively, the associate may preferably select to receive notification of the authorization but only actually execute the submitted transaction. In such embodiments, the authorization may maintain the trade in an executable state for a pre-determined window of time. Following the close of the pre-determined window of time, the authorization may terminate and require that the associate provide an additional request to perform the transaction.

It should be noted that in the embodiments set forth herein, a compliance path for the requested trade may preferably be authorized by the systems and methods if and only if all the required compliance checkpoints are passed. Once all the checkpoints are passed, then the trade request may preferably be sent to the customer's employer platform for final verification. It should be note that in some embodiments the customer's employer platform may be an optional step and not required for final trade execution.

It should be noted as well that, in certain cases where all the checkpoints are satisfied, authorizations may still be denied. These denials may form part of a path where the trade is denied, and returns to a “completed” step without execution, absent a determination of an exception to allow the trade to proceed to execution.

It should be noted that where the denial is based on an employer denial, the outcome may return to the completed step without execution. This outcome may preferably be the same outcome as when the checkpoints are denied.

It should be noted that the path in which an exception is required can also be triggered by failure to satisfy any of the checkpoints.

With respect to the formation of the internal system, the Java Microservices Docker containers, or other suitable systems, may be hosted on compatible cloud sources. Microservices are preferably hosted within dockers at least for reasons of deployability, among other reasons.

A Mongo™ database, or other suitable database, may serve as the backend for the Java Microservices docker. The Mongo™ database may also be hosted on container architecture and be readily deployable.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

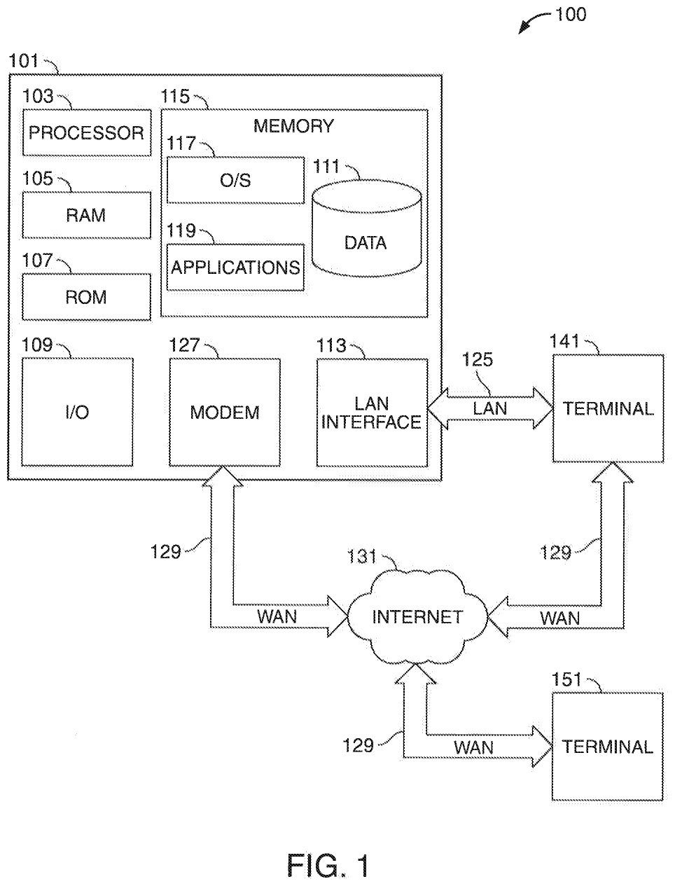

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may have a processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. The processor 103 may also execute all software running on the computer. Other components commonly used for computers, such as EEPROM or Flash memory or any other suitable components, may also be part of the computer 101.

The memory 115 may be comprised of any suitable permanent storage technology—e.g., a hard drive. The memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 is connected to LAN 125 through LAN interface 113 or an adapter. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks. Application program(s) 119 may utilize one or more decisioning processes for the processing of communications involving Artificial Intelligence (AI) as detailed herein.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may utilize the computer-executable instructions executed by a processor. Generally, programs include routines, programs, objects, components, data structures, etc., that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

Any information described above in connection with data 111, and any other suitable information, may be stored in memory 115.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

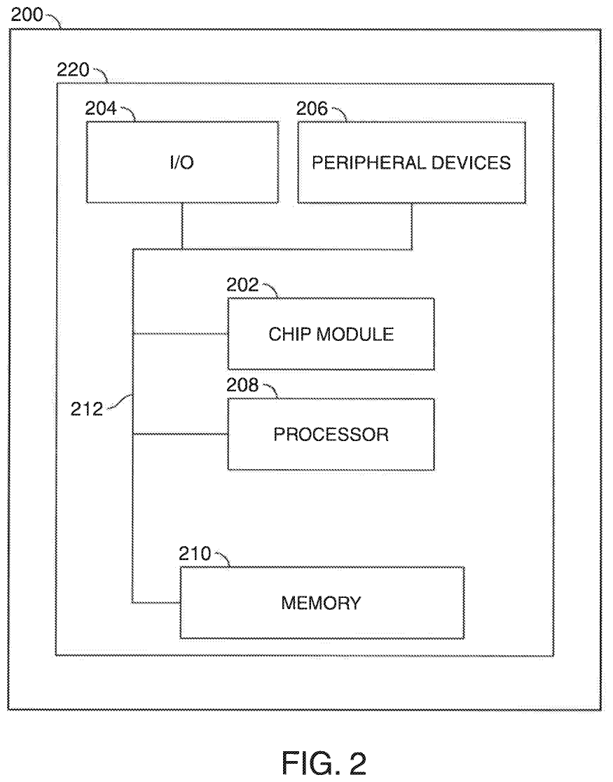

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

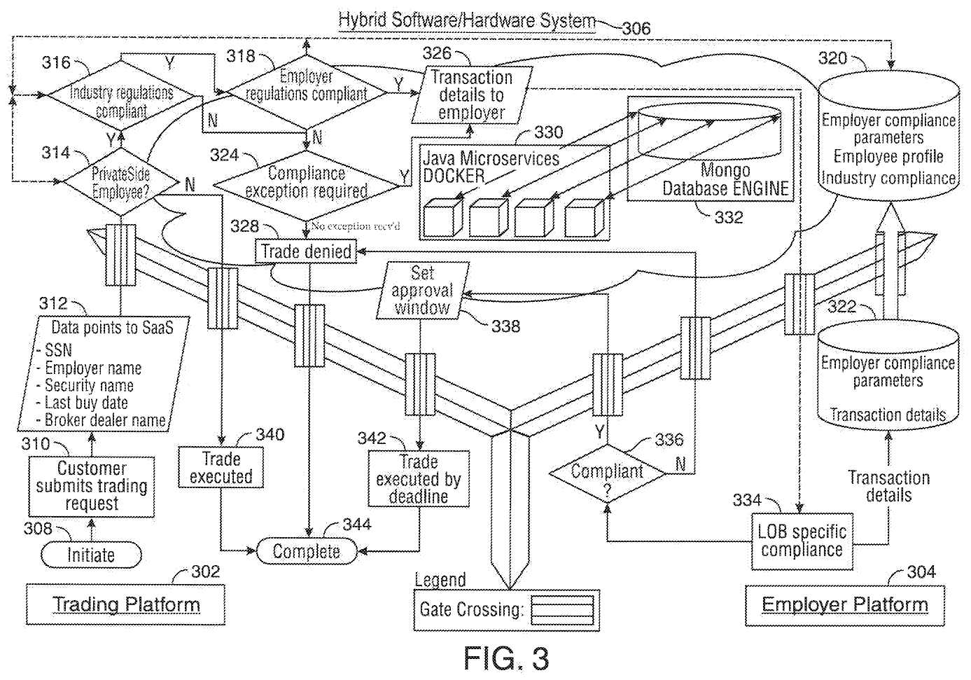

FIG. 3 shows a hybrid illustrative system/process according to the disclosure. FIG. 3 shows a three-pronged system with which the invention may be implemented. At 302, a trading platform for use by a user is shown. At 304, an employer platform is shown. At 306, the software/hardware hybrid system according to the disclosure is shown.

At 308, the trade is initiated by the customer submitting trade request at 310. At 312, one or more of the following data points may be transmitted to software/hardware hybrid system 306: social security number (SSN), the employer name, the name of the security being traded, the last security purchase date of the associate, the broker dealer name associated with the trade and/or any other suitable information used by system review.

At 314, software/hardware hybrid system 306 preferably queries whether the employee requesting the trade is a private side employee—i.e., an employee that is subject to the various requirements and restrictions associated with potentially restricted trading. When the employee is determined to not be a private side employee, then the system may immediately execute the trade, as shown at 340, after which the process is completed, as shown at 344.

When the employee is determined to be a private side employee, then the system may query to determine whether the trade request complies with industry regulations associated with the trade, as shown at 316. These regulations may include one or more of the following regulations—disclosure of all the associates', or the associates immediate family's, trading accounts to the relevant parties, trading restrictions during black-out periods such as periods immediately prior to entity earnings' announcements, and/or a pre-determined—e.g., 30-day—hold period after purchasing a security and a LIFO (Last In First Out) policy for unlocking the hold period—i.e., preferably all hold periods are determined from the last-in-time purchase. Accordingly, if two purchases were made by an associate within the pre-determined time period, the first purchased security cannot be sold until the expiration of the pre-determined time period following the second purchase. The foregoing represents examples of relevant industry regulations, but the systems and methods described herein are sufficiently broad to include any relevant industry regulations.

If the trade is determined to be non-compliant with industry regulations, then an exception to the determination is queried at 324. If no exception to the industry regulations is found, then the trade is denied at shown at 328, and again the process loops to complete at 344.

Either before or after the trade request is found to comply with industry regulations, then software/hardware hybrid system 306 may determine whether the trade request is compliant with employer regulations. Determining whether the trade request is compliant with employer regulations may involve sending transaction details to the employer, as shown at 326.

Thereafter, there may be a further level of specificity involved in employer review of the transaction which may include line of business (LOB) specific review, as shown at 334. Employer compliance is shown in more detail in the leg of the process associated with elements 320, and 324. Specifically, employer compliance parameters, an employee profile and/or industry compliance factors are gathered at 320 and employer compliance parameters as they relate to particular transaction details are shown at 322. Together the foregoing parameters, factors and details are used to determine whether employer compliance is achieved. Certain employer compliance issues may include restrictions relating to speculative trading with respect to the entity's securities. Such a restriction generally prohibits short sales and trading in puts, calls and other options or derivatives with respect to the entity's securities unless the transaction is for legitimate, non-speculative purposes and the employee has obtained prior approval for such transaction. Further, in certain circumstances the entity may designate, or at least recommend, a pre-determined broker-dealer to carry out the trade request.

If the system is shown to be compliant with employer regulations, as shown at 336, then an approval window may be set, as shown at 338. The trade may then be executed by the deadline at 342.

It should be noted that there are numerous approaches, according to the disclosure, to actually authorizing and executing the trade. For example, the software/hardware hybrid system 306 may, following authorization, automatically execute the trade specified in the trade request. Or software/hardware hybrid system 306 may prompt a user to confirm execution of the trade. In such an embodiment, the trade may not be carried out absent user confirmation. In yet another embodiment, software/hardware hybrid system 306 may provide a user an Artificial Intelligence (AI) based system for solving the reasons for non-compliance and thereby provide a user with a roadmap to correcting a non-compliant trade. As such, the user may be prompted with an opportunity to correct the trade and submit the trade request in a compliant fashion. It should be noted that the prompting of the user to make the trade compliant, and offering instructions therefore, may occur preferably only when the trade is determined to be non-compliant with industry or employer regulations.

It should be noted that Java Microservices DOCKER containers 330 and Mongo Database ENGINE 332 are shown schematically within the cloud set forth in software/hardware hybrid system 306. These components preferably provide the hardware backbone for determining compliance as set forth herein.

Certain embodiments may involve real time systems that leverage artificial intelligence (AI) mechanisms. These mechanisms are primarily used to rectify denied, or potentially denied, trading requests. Following rectification, the trade request may be resubmitted and executed.

The following are possible use cases for an AI based system for rectifying denied or potentially denied trading requests.

In one case, the system may detect, preferably in real time, that a trading request is not industry compliant. For example, the system may detect that an associate is attempting to trade within a blackout period, e.g. within 15 days prior to an earnings announcement. The system may deny the trade based on information regarding the entity earnings announcement schedule and prompt the associate to select an alternate date of trade execution.

Based on the associate's historical trading record, the system could initiate a future notification and trading training program to train the associate to comply with trading restrictions. AI may determine the content and/or the frequency of electronic messaging, or emails, related to denied trading requests. Future behavior that complies with appropriate trading restrictions may preferably serve to reduce the frequency of such notifications, according to the AI mechanism in place.

Another use case may involve a trade request that violates employer regulations such as speculative trading of an entity's securities. A similar pattern as the one described above with respect to industry trading regulations may be evoked to eliminate attempts by an associate to trade using speculative trading that violates employer restrictions.

In this use case, AI may again be implemented to electronically message an associate regarding accepted trading and prohibited trading. The content of such messaging and/or emails could again be modified both as to content and frequency as necessary to prevent future violations and to encourage compliant trading.

It should be noted as well that AI could be leveraged to increase system diligence and security levels, possibly with respect to an associate flagged with improper trading behavior, as needed to prevent future incidents. Such increased diligence may be pro-active steps to identify the trading accounts of the associate and/or the associate's immediate family and monitor activity of these accounts.

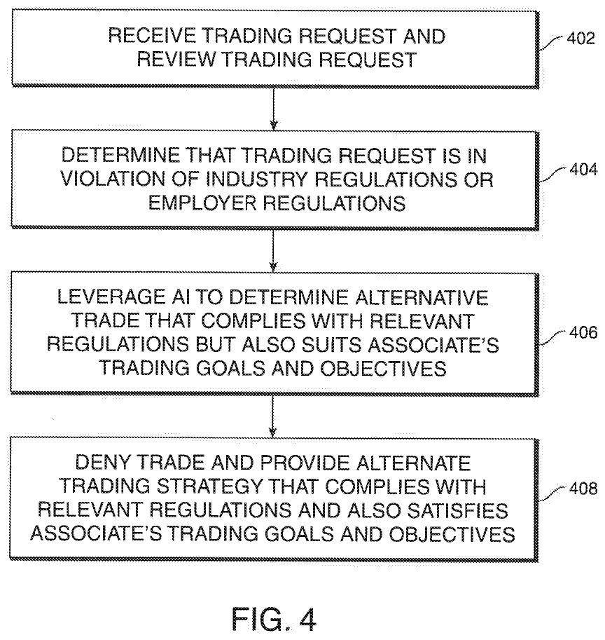

FIG. 4 shows an illustrative flow diagram of an embodiment of a process, using one or more of the systems described herein, that leverages AI to improve compliance with various trading regulations. At 402, a system according to the disclosure is shown receiving associate trading requests and reviewing the received trading requests.

At 404, the system determines that one or more of the received trading requests violate industry trading regulations and/or employer trading regulations.

At 406, the system preferably leverages AI to determine alternative trades and/or trading strategies that comply with relevant regulations. Preferably, the AI may also be leveraged to provide alternative trades and/or trading strategies that suit the associates trading goals and objectives as well as comply with relevant regulations.

At the end of the review of the associate trading requests, the system may deny illegal trades and provide the associate with alternate trades and/or trading strategies that comply with relevant regulates at the same time as satisfying the associates trading goals and objectives.

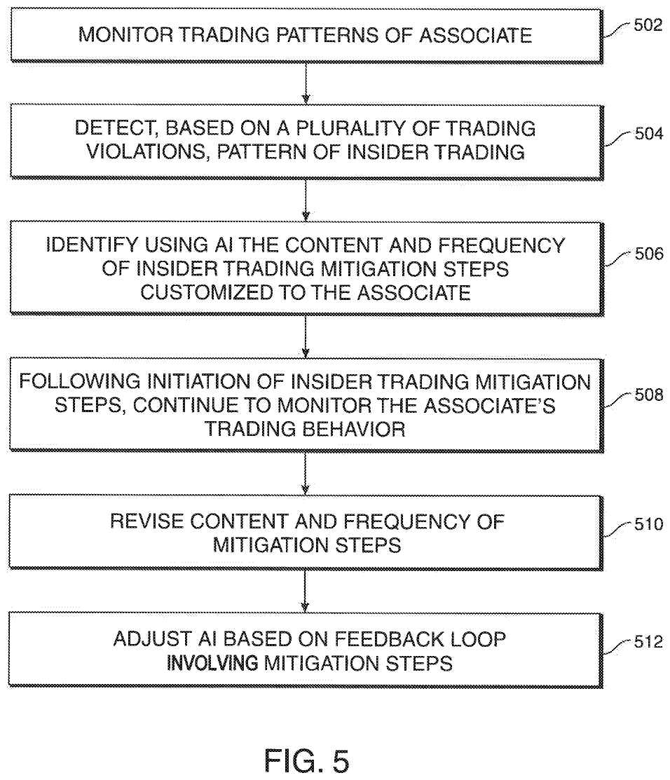

FIG. 5 shows another illustrative flow diagram of an embodiment of a process, using one or more of the systems described herein. Step 502 shows monitoring trading patterns of one or more associates. Step 504 shows detecting, based on a plurality of trading violations of the associate, a pattern of insider trading.

At 506, the system may identify, using A.I., a content and frequency of insider trading mitigation steps that have been customized based on the associate's past trading behavior. Such steps may include electronic messaging to the associate, a series of e-mails before, during and after entity earnings announcements, or any other suitable mitigation steps. Following initiation of insider trading mitigation steps, the process, at 508, continues to monitor the associate's trading behavior.

The continued monitoring may involve revising the content and frequency of insider trading mitigation steps, as shown at 510. The feedback received in response to the continued monitoring of the associate's trading behavior may also be used to adjust the AI, as shown at 512.

For example, while the messaging associated with mitigating the insider trading may typically run proportionally to the associate's attempted trades, the first messaging response to the associate's trades may obtain a chilling effect on the associate's trading behavior. The AI may seek to avoid such a chilling effect which may, at best, reduce the associate's trading and, at worst, may provoke the associate to take his or her trading to a different, perhaps non-reported, trading platform. As such, AI may use this information to reduce the frequency and potency of initial messaging, but increase such frequency and potency as trade request denials continue. Other strategies for AI, which include strict proportionality, sliding scale proportionality depending on the appropriateness of the request, or other suitable strategies are possible to use as a training set or starting group, which can be further refined with more involved AI usage and feedback.

Thus, systems and methods for providing enhanced security features in a REAL TIME SYSTEM WITH ARTIFICIAL INTELLIGENCE (AI) MECHANISM FOR RECTIFYING TRADING REQUESTS DENIED BASED ON ASSOCIATED INVESTMENT POLICY (AIP)GOVERNANCE. Persons skilled in the art will appreciate that the present invention can be practiced by other than the described embodiments, which are presented for purposes of illustration rather than of limitation. The present invention is limited only by the claims that follow.

What is claimed is:

1. One or more non-transitory computer-readable media storing computer-executable instructions which, when executed by a processor on a computer system, perform a method for integrating trading account security with associate investment policy (AIP) governance, the method comprising:
receiving, from an associate via an associate trading platform, an associate trade request, said trade request comprising an employee social security number (SSN), an associate name, a name of a security to which the trade request is directed, a last security purchase data, the last security purchase data associated with the security, and a broker dealer name to which the trade request is directed;
determining that the employee is a private side employee;
when the employee is a private side employee, using a series of containers in electronic communication with a database engine to determine that the trade request is industry compliant;
using the series of containers in electronic communication with the database engine to determine that the trade request is employer regulations compliant;
following a determination that the trade request is industry compliant and employer regulations compliant, transmitting the trade request to an employer platform;
following the transmitting the trade request to the employer platform, informing the employee that the employee can execute the trade request within a pre-determined time period;
prompting the employee with a selectable option to execute the trade request; and
when the trade request is determined to be non-compliant, then electronically messaging or e-mailing the employee 1) a trade denial and 2) insider trading mitigation messages to obtain reduced future insider trading.

2. The method of claim 1, wherein the determination that the trade request is non-compliant is based at least in part on a pre-determined set of employer compliance parameters and an employee profile corresponding to the private side employee.

3. The method of claim 1, wherein the determination that the trade request is non-compliant is based at least in part on the private side employee social security number (SSN), the employee name, the name of the security to which the trade request is directed, the last security purchase data, the last security purchase data associated with the security, and the broker dealer name to which the trade request is directed.

4. The method of claim 1, wherein prompting the employee with a selectable option to execute the trade request further comprises prompting the employee with a selectable option to execute the trade request within a pre-determined window of time following the receiving of the trade request.

5. The method of claim 1 wherein the prompting the employee with a selectable option to execute the trade request further comprises prompting the employee with a selectable option to execute the trade request within a pre-determined window of time following the determination that the trade request is industry compliant and employer regulations compliant.

6. The method of claim 1 wherein prompting the employee with a selectable option to execute the trade request is performed in real time with respect to the receiving of an associate selection to execute the trade request.

7. The method of claim 1 wherein the receiving the trade request, the determining that the employee is a private side employee, and the using the series of microservices containers in electronic communication with a database engine to determine that the trade request is industry compliant are performed in real time with respect to the receiving of the trade request.

8. The method of claim 1 wherein the prompting the employee with a selectable option to execute the trade request comprises sending, following a selection by the employee to execute the trade request, a trade execution response to the trading platform to execute the trade request.

9. A computer system for integrating trading account security with associate investment policy (AIP) governance, the computer system comprising:
a receiver, said for receiving from an employee via an associate trading platform an associate trade request, said trade request comprising an associate social security number (SSN), an associate name, a name of a security to which the trade request is directed, a last security purchase data, the last security purchase data associated with the security, and a broker dealer name to which the trade request is directed;
a processor for determining that the employee is a private side employee;
when the employee is a private side employee, the processor further configured to use a series of containers in electronic communication with a database engine to determine that the trade request is industry compliant;
the series of containers in electronic communication with the database engine further configured to determine that the trade request is employer regulations compliant; and
when the trade request is determined to be non-compliant, then electronically messaging or e-mailing the employee 1) a trade denial and 2) a plurality of insider trading mitigation messages to reduce or eliminate future insider trading;
wherein, following a determination that the trade request is industry compliant and employer regulations compliant, the processor is further configured to transmit the trade request to an employer trading platform, and processor is yet further configured to include together with the trade request an instruction to inform the employee that the employee can execute the trade request within a pre-determined time period and to provide, following informing the employee that the employee can execute the trade request within a pre-determined time period, to the employee a selectable option to execute the trade request.

10. The computer system of claim 9, wherein the determination that the trade request is employer regulations non-compliant is based at least in part on a pre-determined set of employer compliance parameters and an employee profile corresponding to the private side employee.

11. The computer system of claim 9, wherein the determination that the trade request is employer regulations non-compliant is based at least in part on the private side employee social security number (SSN), the employee name, the name of the security to which the trade request is directed, the last security purchase data, the last security purchase data associated with the security, and the broker dealer name to which the trade request is directed.

12. The computer system of claim 9, wherein the processor is further configured to, prior to transmitting the trade request to the employee trading platform, modify the trade request to include an instruction to terminate the trade request within a pre-determined window of time following the receipt, by the employee trading platform, of the trade request.

13. The computer system of claim 9 wherein the processor is further configured to modify the trade to include an instruction for prompting the employee with a selectable option to execute the trade request within a pre-determined window of time following informing the employee that the trade request can execute the trade request.

14. The computer system of claim 9 wherein the processor is configured to modify the trade request to be performed in real time with respect to a receiving a selection by the employee to execute the trade request.

15. The computer system of claim 9 wherein the processor is configured to use the series of microservices containers in electronic communication with a database engine to determine that the trade request is industry compliant in real time with respect to the receiving of the trade request.

16. The computer system of claim 9 wherein, following prompting the employee with a selectable option to execute the trade request and in response to receiving a selection by the employee to execute the trade request, the processor is configured to send a trade execution response to the trading platform to execute the trade request.

17. A computer system for integrating trading account security with associate investment policy (AIP) governance, the computer system comprising;
a processor for executing computer-executable instructions;
a receiver, for receiving an associate trade request from an employee via an associate trading platform, said trade request comprising an associate social security number (SSN), an associate name, a name of a security to which the trade request is directed, a last security purchase data, the last security purchase data associated with the security, and a broker dealer name to which the trade request is directed;
the processor for determining that the employee is a private side employee;
when the employee is a private side employee, the processor further configured to use a series of containers in electronic communication with a database engine to determine that the trade request is industry compliant; and
the series of containers in electronic communication with the database engine further configured to determine that the trade request is employer regulations compliant;
wherein when the trade request is determined to be non-compliant, then electronically messaging or e-mailing the employee 1) a trade denial and 2) a plurality of insider trading mitigation messages to reduce or eliminate future insider trading; and
wherein, following a determination that the trade request is industry compliant and employer regulations compliant, the processor is further configured to transmit the trade request to an employer trading platform, and processor is yet further configured to include together with the trade request an instruction to inform the employee that the employee can execute the trade request within a pre-determined time period and to provide, following informing the employee that the employee can execute the trade request within a pre-determined time period, to the employee a selectable option to execute the trade request.
